(19) United States
(12) Patent Application Publication
(10) Pub. No.: US 2008/0019714 A1
(43) Pub. Date: Jan. 24, 2008

(54) Image forming apparatus and print head

(75) Inventor: Hiroyuki Yamamoto, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/826,802

(22) Filed: Jul. 18, 2007

(30) Foreign Application Priority Data
Jul. 18, 2006 (JP) 2006-195661

(51) Int. Cl. G03G 15/01; G03G 15/043

(52) U.S. Cl. 399/40; 399/51

(57) ABSTRACT

An image forming apparatus includes: a photosensitive body; a print head for exposing the photosensitive body; a synchronous pattern detection unit which is disposed so as to be integrated into the print head, the synchronous pattern detection unit detecting a synchronous pattern which is previously formed on an unexposed part of the photosensitive body; a synchronous signal generation unit for generating a synchronous signal based on a detected signal from the synchronous pattern detection unit; and a control unit for controlling a drive of the print head based on the generated synchronous signal.

### BACKGROUND OF THE INVENTION

1. Field of the Invention

The present invention relates to an image forming apparatus and a print head.

2. Description of Related Art

An image forming apparatus based on an electrophotographic type of method, in which for example, DC motors to drive a photosensitive drum, a developing unit, a conveyance belt, a fixing unit, a print paper conveyance unit are used. A rotation speed of DC motors is controlled, for example, under the PLL feedback control by attaching a rotary encoder for detecting the rotation of the motor to a motor shaft to compare an output signal of the rotary encoder with the reference clock. Particularly, in a color printing apparatus using a tandem method, the above mentioned control is required to be carried out at a high speed, for example, in order to ensure the accuracy of color registration and image position of magenta (M), cyan (C), and yellow (Y). A rotary encoder of DC motors normally outputs 30 to 50 pulses per one rotation. In the case of DC motors, the above-mentioned number of pulses is appropriate since the pulses are generated by induced voltage caused by a magnet in consideration of the cost. That is, in the conventional motor control method, a crystal frequency for the reference clock is generally determined after the number of pulses is suitably determined and the output frequency of the rotary encoder is determined based on the number of motor rotation.

Meanwhile, the above number of pulses outputted from a rotary encoder is used for controlling a motor at a constant speed. Thus, the number of pulses of rotary encoder does not have any meaning on the image. Unevenness of rotation cannot be reduced to zero even though the speed control is carried out as described above. For example, by the fluctuation of various loads in a printing apparatus, unevenness of rotation is generated. As a result, the problem that the image is slightly expanded and contracted in sub-scanning direction, is caused. By the problem, the color shift is caused in a color image forming apparatus.

Conventionally, as a method for preventing image quality degradation, the technique in which the number of rotary encoder pulses of a driving motor is determined so as to be the same frequency as that of the horizontal synchronous signal (HSYNC signal), and the horizontal synchronous signal is controlled to synchronize with the unevenness of rotation of the driving motor to absorb the unevenness of rotation due to the fluctuation caused by various loads, has been proposed (for example, refer to Japanese Patent Laid open No. 2001-188455). Further, another technology in which a rotation angle of driving motor for driving the photosensitive body is detected by a rotary encoder and an exposure unit is controlled by synchronizing with the main scanning synchronous signal which is generated by synchronizing with the output from this rotary encoder, has been proposed (for example, refer to Japanese Patent Laid Open No. 2003-149881).

Furthermore, regarding a color shift correction device for a color electrophotographic apparatus such as a full color copy machine and full color printer, for recording an image by using an electrophotographic process method, the technology in which an optical reading unit or an electric reading unit for reading a mark which is previously attached to a non-image part on a photosensitive body and which has a different light reflectance or a different resistivity from that of the photosensitive body, is provided as a synchronous detection unit, and the original position of the main scanning direction matches with the original position of the sub scanning direction in an optical writing system when the displacement is corrected based on the detected mark position, has been proposed (for example, refer to Japanese Patent Laid Open No. H07-66953).

However, in the conventional technologies described in Japanese Patent Laid Open No. 2001-188455 and Japanese Patent Laid Open No. 2003-149881, the problem the cost thereof is increased is caused because the relatively expensive rotary encoders are used. Further, in Japanese Patent Laid Open No. H07-66953, the arrangement position of the print head is different from that of the synchronous detection unit with respect to the photosensitive body, since the print head and the synchronous detection unit are arranged as separate bodies. Therefore, in order to carry out an accurate position adjustment, it is necessary to perform the control in consideration of the relative position between the print head and the synchronous detection unit with respect to the photosensitive body. The processing required for the control becomes complex. Further, there is a possibility that a stable image forming cannot be carried out because it is difficult to accurately grasp the relative position with respect to the photosensitive body.

### SUMMARY

An object of the present invention is to provide an image forming apparatus and a print head which can carry out a stable image forming with a low cost and simple construction.

In order to achieve at least one of the aforementioned objects, in accordance with an embodiment according to one aspect of the present invention, an image forming apparatus comprises:

a photosensitive body;

a print head for exposing the photosensitive body;

a synchronous pattern detection unit which is disposed so as to be integrated into the print head, the synchronous pattern detection unit detecting a synchronous pattern which is previously formed on an unexposed part of the photosensitive body;

a synchronous signal generation unit for generating a synchronous signal based on a detected signal from the synchronous pattern detection unit; and

a control unit for controlling a drive of the print head based on the generated synchronous signal.

In the above described image forming apparatus, preferably, the photosensitive body comprises the unexposed part at one end or both ends in a main scanning direction of the photosensitive body; and the synchronous pattern detection unit is disposed at a position corresponding to the unexposed part.

Further, in the above described image forming apparatus, preferably, the print head comprises a plurality of recording elements arranged in an array in a main scanning direction of the photosensitive body; and the synchronous pattern detection unit is disposed at one end or both ends of the array.

Further, in the above described image forming apparatus, preferably, the synchronous pattern detection unit is disposed on a same semiconductor substrate as the plurality of recording elements.

Further, in the above described image forming apparatus, preferably, the synchronous pattern is formed in an optically detectable state; and the synchronous pattern detection unit detects the synchronous pattern optically.

Further, in the above described image forming apparatus, preferably, the synchronous pattern is formed in a magnetically detectable state; and the synchronous pattern detection unit detects the synchronous pattern magnetically.

Further, preferably, the image forming apparatus is a color image forming apparatus for forming a color image by overlapping a plurality of images having respective colors; and the image forming apparatus comprises the photosensitive bodies for the respective colors and the print heads for the respective colors.

### BRIEF DESCRIPTION OF THE DRAWINGS

The present invention will become more fully understood from the detailed description given hereinafter and the accompanying drawings given by way of illustration only, and thus are not intended as a definition of the limits of the present invention, and wherein:

FIG. 1 is a view showing a construction of the image forming apparatus according to an embodiment of the present invention;

FIG. 2 is a view showing a LED print head which is seen from a surface on which recording elements are mounted, according to the embodiment of the present invention;

FIG. 3 is a schematic view showing relative position between a photosensitive drum and an LED elements group unit disposed at-the end of the LED print head according to the embodiment; and

FIG. 4 is a block diagram showing a control system for the operation of the LED print head according to the embodiment.

### DETAILED DESCRIPTION OF PREFERRED EMBODIMENT

Hereinafter a detailed description of an embodiment of the present invention will be given with reference to the drawings.

First, a construction of the embodiment is explained.

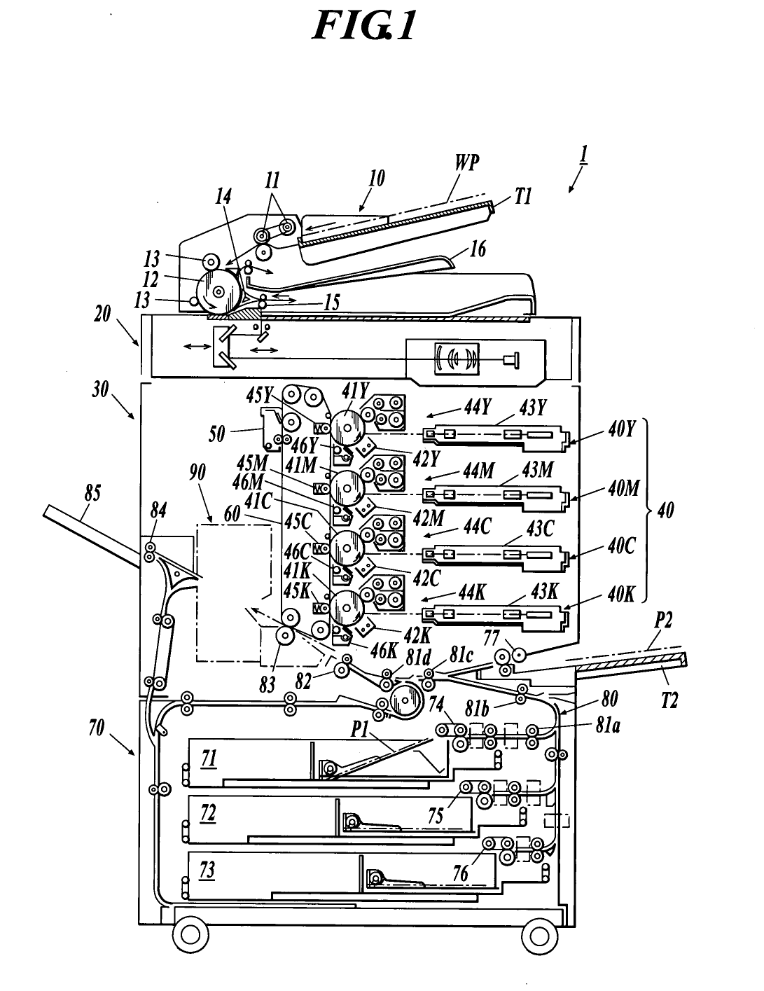

FIG. 1 shows a schematic sectional view of the construction of an image forming apparatus 1 according to the embodiment.

The image forming apparatus 1 is a digital complex machine comprising various functions such as a copying function in which an image is read from a document WP and the read image is formed on a recording medium P, such as paper, and a printing function in which an image data is received from a personal computer or the like, an image which the image data shows is formed on a recording medium P and the recording medium is outputted. As shown in FIG. 1, the image forming apparatus 1 comprises an automatic document feeder unit 10, an image reading unit 20, and a printing unit 30.

The automatic document feeder unit 10 is called as ADF (Auto Document Feeder) and feeds a document WP set on a document tray T1 to a reading part of the image reading unit 20 one by one.

The automatic document feeder unit 10 comprises: a feeding roller 11 for feeding a document WP set on the document tray T1 sequentially from the top of the document WP; a contact roller 12 for passing the document WP while the document WP is in contact with a contact glass which is a reading part for the document WP; a guiding roller 13 for guiding the document WP which is fed by the feeding roller 11, along the contact roller 12. Further, the automatic document feeder unit 10 comprises: a switch pawl 14 for switching a feeding direction of the document WP which passes through the contact glass; a turning roller 15 for turning over the document from the front to the back; a paper discharging tray 16 for discharging the document which has been already read.

The image reading unit 20 comprises a scanner which comprises a light source, lenses, a contact glass, CCD (Charge Coupled Device), and the like. The image reading unit 20 reads an image of the document WP by forming an image using a reflected light of light with which the document is irradiated and by carrying out the photoelectric conversion of the formed image and outputs the image to the printing unit 30. Here, the image includes not only image data such as figure, photographs or the like but also text data such as characters, symbols or the like.

The printing unit 30 comprises an image forming unit 40, a cleaning unit 50, an intermediate transfer belt 60, a paper supply unit 70, a conveyance unit 80, and a fixing device 90.

The image forming unit 40 comprises image forming units 40Y, 40M, 40C, and 40K for respective colors, which form images of yellow, magenta, cyan, and black, respectively. For example, the image forming unit 40Y comprises a charger device 42Y arranged around a photosensitive drum 41Y, an LED print head 43Y as an exposure device, a developing device 44Y, a primary transfer roller 45Y, and a cleaning device 46Y, and forms a yellow (Y) image.

Specifically, an electrostatic latent image is formed on the photosensitive drum 41Y which is charged by the charger device 42Y and is irradiated (exposed) with the light from the LED print head 43Y. The developing device 44Y develops the electrostatic latent image by attracting charged toner to the surface of the photosensitive drum 41Y where the electrostatic latent image is formed. While the photosensitive drum 41Y to which the toner is attracted by the developing device 44Y rotates at a constant speed, the toner image is transferred to an intermediate transfer belt 60 which is described later, at a transfer position where the primary transfer roller 45Y is located. After the toner image is transferred to the intermediate transfer belt 60, the cleaning device 46Y removes residual charges, residual toner, and the like from the surface of the photosensitive drum 41Y.

The LED print head 43Y comprises, as recording elements, a plurality of light emitting diodes (LED) arrayed in the direction along the axis of the photosensitive drum 41Y (main scanning direction X) and an optical unit having a plurality of Graded-Index lenses (GRIN) arrayed in the main scanning direction X. Each LED of the LED print head 43Y is selectively activated based on the image data formed by an image expanding control unit which is described later, and the light irradiated from an activated LED is focused on the photosensitive drum 41Y to form an image.

At one end or both ends of the arrayed recording elements, a synchronous pattern detection unit 48 which comprises light emitting diodes, phototransistor elements, and the like, for optically reading a synchronous pattern which is previously formed on the non-exposed part of the photosensitive drum 41Y, is provided.

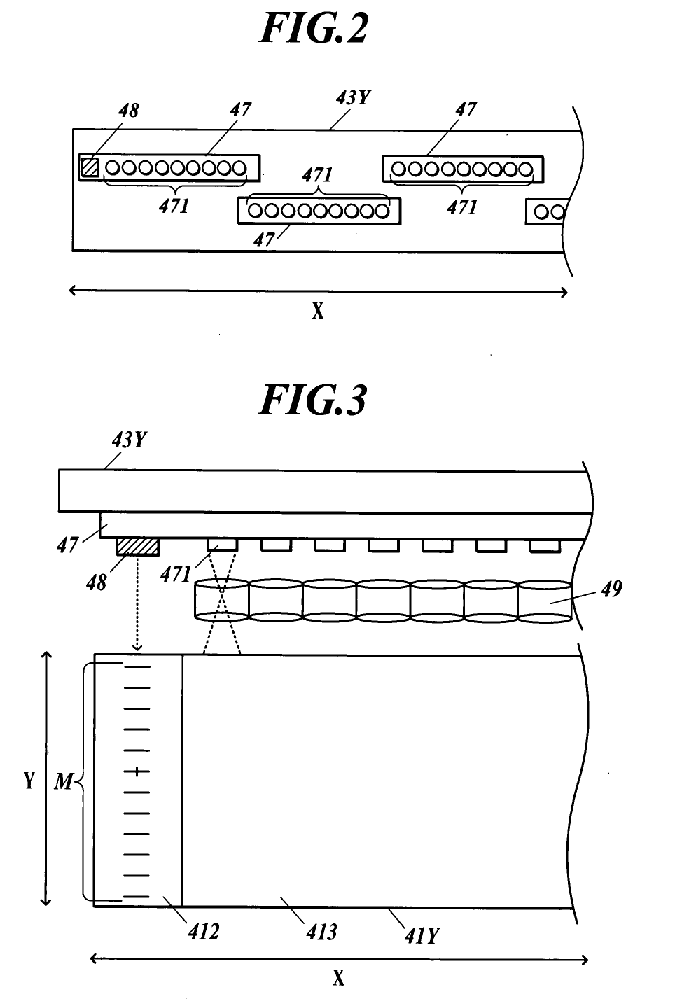

FIG. 2 is a view showing an example of the LED print head 43Y which is seen from the surface on which the LED print head is mounted. As shown in FIG. 2, on the LED print head 43Y, LED elements group units 47 comprising a plurality of LEDs 471 are arranged in an array in the main scanning direction X of the photosensitive drum 41Y. The synchronous pattern detection unit 48 is disposed so as to be integrated with the LED print head 43Y at one end portion of a plurality of the LEDs 471 which are arranged as the LED elements group unit 47.

The photosensitive drum 41Y comprises an exposed part which is exposed by the LED print head 43Y and an unexposed part which is disposed at one end or both ends of the photosensitive drum 41Y in the main scanning direction. At the unexposed part, a synchronous pattern having at least one or more marks which can be optically detected is previously formed. The synchronous pattern is detected by the synchronous pattern detection unit 48 of the LED print head 43Y.

FIG. 3 is a schematic view showing relative position between the photosensitive drum 41Y and the LED elements group unit 47 (side view) disposed at the end of the LED print head 43Y. As shown in FIG. 3, the photosensitive drum 41Y comprises an unexposed part 412 and an exposed part 413 which is exposed by the LED print head 43Y. At the exposed part 413 of the photosensitive drum 41Y, by forming an image using the light from the LEDs 471 focused by GRIN lenses 49, the image to be printed based on image data is exposed.

At the unexposed part 412 of the photosensitive drum 41Y, a synchronous pattern M which has a different light reflectance from the surface of the unexposed part 412 along the circumferential direction (sub-scanning direction Y) of the photosensitive drum 41Y, is previously formed. Here, the synchronous pattern M may be formed as “pits” which are used for recording data in CD (Compact Disk) or the like. In this case, an optical pick-up device or the like is preferably used as the synchronous pattern detection unit 48.

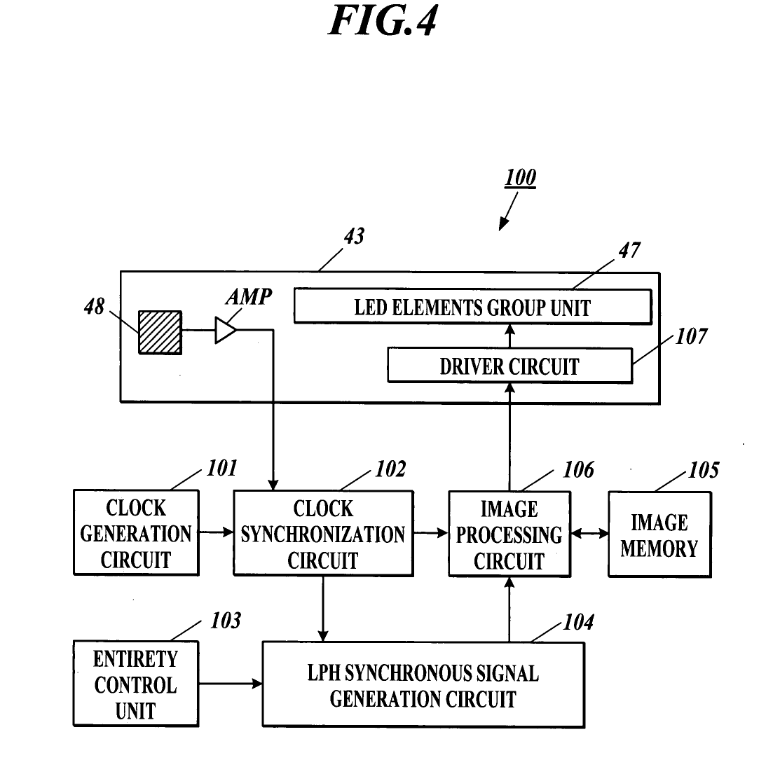

The synchronous pattern detection unit 48 sequentially detects the synchronous pattern M formed on the unexposed part 412 according to the rotation of the photosensitive drum 41Y and outputs a pulse-shaped detected signal to a clock synchronization circuit which will be described later (refer to FIG. 4). Therefore, it is possible to efficiently detect unevenness of rotation of the photosensitive drum 41Y. When the unexposed parts 412 are disposed at both ends of the photosensitive drum 41Y, synchronous patterns M formed on both unexposed parts 412 are preferably the same patterns. Therefore, it is possible to detect distortions such as twist of the photosensitive drum 41Y.

In the same way, the image forming units 40M, 40C, and 40K comprises charger devices 42M, 42C and 42K arranged around the photosensitive drums 41M, 41C and 41K, LED print heads 43M, 43C and 43K, developing devices 44M, 44C and 44K, primary transfer rollers 45M, 45C and 45K, and cleaning devices 46M, 46C and 46K and form a magenta (M) image, cyan image (C), and black image (K) respectively.

The intermediate transfer belt 60 is an endless semiconductive belt which is rotatably supported by extending between a plurality of rollers and is driven so as to rotate according to the rotation of the rollers.

The intermediate transfer belt 60 is pressed against each of the photosensitive drums 41Y, 41M, 41C and 41K by the primary transfer rollers 45Y, 45M, 45C and 45K respectively. The developed toner images on the surfaces of the photosensitive drums 41Y, 41M, 41C, and 41K are transferred on the intermediate transfer belt 60 at transfer positions determined by the primary transfer rollers 45Y, 45M, 45C, and 45K, respectively. The toner images of yellow, magenta, cyan, and black are further transferred so as to be sequentially overlapped on the recording medium P at a transfer position determined by a secondary transfer roller 83.

The paper supply unit 70 comprises a plurality of paper supply cassettes 71, 72, and 73 and a manual tray T2. In the paper supply cassettes 71, 72, and 73, standard recording media P1 which are previously classified into each size or into each type of paper are contained in each paper supply cassette. By paper supply rollers 74, 75, and 76, standard recording media P1 which are contained in a paper supply cassette, are conveyed from the top thereof one by one toward the conveyance unit 80. The manual tray T2 can set nonstandard recording media P2 having various nonstandard sizes depending on user's needs. The paper size and the width of the set nonstandard recording media P2 are detected and the set nonstandard recording media P2 are conveyed from the top thereof by a paper supply roller 77 toward the conveyance unit 80 one by one.

The conveyance unit 80 conveys a standard recording medium P1 or nonstandard recording medium P2 (hereinafter P1 and P2 are referred in total as a recording medium P) which is conveyed from the paper supply cassettes 71, 72, and 73 or manual tray T2 toward the secondary transfer roller 83 via a plurality of intermediate rollers 81a, 81b, 81c, and 81d and a resist roller 82. By the secondary transfer roller 83, the color toner images transferred on the intermediate transfer belt 60 are collectively transferred on a recording medium P.

On the recording medium P on which color toner images of yellow, magenta, cyan, and black are transferred, the toner image transferred on the recording medium P is thermally fixed at the fixing device 90. The recording medium P for which the fixing process is carried out, is supported by pinching the medium with a paper discharge roller 84 and is outputted on a paper discharge tray 85.

Meanwhile, after the color toner image is transferred on recording medium P by the secondary transfer roller 83, residual toner is removed by the cleaning unit 50 from the intermediate transfer belt 60 which is electrostatically separated by using the curvature thereof from the recording medium P.

FIG. 4 is a block diagram showing a control system 100 regarding the operation of the LED print head 43 (43Y, 43M, 43C, and 43K) of the image forming apparatus 1.

As shown in FIG. 4, the control system 100 comprises a clock generation circuit 101, a clock synchronization circuit 102, an entirety control unit 103, an LPH synchronous signal generation circuit 104, an image memory 105, an image processing circuit 106, a driver circuit 107, and the like. In the present embodiment, among the circuits in the control system 100, at least the clock synchronization circuit 102, the LPH synchronous signal generation circuit 104, and the image processing circuit 106 are provided in the LED print head 43 (43Y, 43M, 43C, and 43K) for each color. However, the construction of the control system 100 is not limited to this. These circuits may be commonly used in all of the LED print heads 43.

The clock generation circuit 101 comprises a clock generation unit (not shown) such as a crystal oscillator for always generating a clock signal having a constant frequency and outputs a clock signal generated by the clock generation unit to the clock synchronization circuit 102.

The clock synchronization circuit 102 generates a main scanning synchronous signal which is a reference for the main scanning direction during the image forming based on the clock signal from the clock generation circuit 101 and a detected signal of synchronous pattern from the synchronous pattern detection unit 48, which is inputted via an amplifier circuit AMP and outputs the main scanning synchronous signal to the LPH synchronous signal generation circuit 104 and the image processing circuit 106.

The entirety control unit 103 comprises a CPU (Central Processing Unit), a ROM (Read Only Memory), a RAM (Random Access Memory), and the like (either of them is not shown).

The entirety control unit 103 reads out a system program which is previously stored in ROM, various processing programs, data, and the like and expands them in the RAM. Then, the entirety control unit 103 collectively controls the operation of each unit of the image forming apparatus 1 according to the expanded program.

Further, the entirety control unit 103 temporarily stores image data inputted via an external I/F (not shown) and image data transmitted from the image reading unit 20 in RAM (not shown). Then, the entirety control unit 103 generates data (print data) to be printed out based on the image data and stores the data in the image memory 105.

Further, the entirety control unit 103 collectively controls various driving mechanisms and sensors in the image forming apparatus 1. For example, the entirety control unit 103 controls motors so as to rotate the photosensitive drums 41 (41Y, 41M, 41C, and 41K).

Furthermore, the entirety control unit 103 generates a sub-scanning synchronous signal which is a reference for the sub-scanning direction during the image forming and outputs the signal to the LPH synchronous signal generation circuit 104.

The LPH synchronous signal generation circuit 104 corrects the start position of the sub-scanning synchronous signal inputted from the entirety control unit 103 based on the start position of the main scanning synchronous signal inputted from the clock synchronization circuit 102 and outputs the corrected sub-scanning synchronous signal to the image processing circuit 106.

The image memory 105 comprises DRAM (Dynamic RAM) or the like. The image memory 105 is a memory which stores print data generated by the entirety control unit 103.

The image processing circuit 106 generates a control signal according to print data stored in the image memory 105 based on the main scanning synchronous signal inputted from the clock synchronization circuit 102 and the sub-scanning synchronous signal inputted from the LPH synchronous signal generation circuit 104 and outputs the control signal to the driver circuit 107.

The driver circuit 107 is a circuit which drives the LEDs 471 and corrects an amount of light of the LEDs 471 included in the LED elements group unit 47 based on the control signal inputted from the image processing circuit 106.

Hereinafter, the operation of the above control system 100 is described.

First, under the control of the entirety control unit 103, the photosensitive drum 41 is rotated and the synchronous pattern formed on the unexposed part 412 of the photosensitive drum 41 is detected by the synchronous pattern detection unit 48.

The clock synchronization circuit 102 generates the main scanning synchronous signal based on the detected signal inputted from the synchronous pattern detection unit 48 and a clock signal inputted from the clock generation circuit 101, and outputs the main scanning synchronous signal to the LPH synchronous signal generation circuit 104 and the image processing circuit 106.

The LPH synchronous signal generation circuit 104 into which the main scanning synchronous signal is inputted corrects the start position of the sub-scanning synchronous signal inputted from the entirety control unit 103 based on the start position of main scanning synchronous signal and outputs the corrected sub-scanning synchronous signal to the image processing circuit 106.

The image processing circuit 106 generates a control signal according to the print data in the image memory 105 based on the main scanning synchronous signal inputted from the clock synchronization circuit 102 and sub-scanning synchronous signal inputted from the LPH synchronous signal generation circuit 104. By outputting the control signal to the driver circuit 107, the drive of the LEDs 471 is controlled.

As described above, according to the embodiment, by the synchronous pattern detection unit 48 which is disposed so as to be integrated with the LED print head 43, a synchronous pattern formed on the unexposed part of the photosensitive drum 41 is detected. Based on the synchronous signal generated from the synchronous pattern, the exposure timing for the print head is controlled. Therefore, the relative position between the print head and the synchronous pattern detection unit 48 with respect to the photosensitive drum 41 can be fixed. As a result, it is not necessary to consider the above relative position. Since the exposure timing for the print head can be controlled based on the detected synchronous pattern, it is not necessary to use a rotary encoder. The stable image forming can be carried out with a low cost and a simple construction.

The detailed construction and the operations of the image forming apparatus in the above embodiment can be modified in various ways without departing from the gist of the present invention.

For example, in the above embodiment, the synchronous pattern can be optically detected. However, the present invention is not limited to this. The synchronous pattern may be magnetically detected by forming the synchronous pattern with the material having a different magnetic susceptibility from the surface of the unexposed part 412. Further, a magnetic tape or the like on which the synchronous pattern is previously recorded may be also attached to the unexposed part 412. In the above cases, in the synchronous pattern detection unit 48, a magnetic head and the like which can detect the synchronous pattern magnetically, is used.

Further, in the above embodiment, a drum type of photosensitive body is used. However, the present invention is not limited to this. A belt type of photosensitive body may also be used.

Further, the synchronous pattern detection unit 48 may be disposed on the same semiconductor substrate as LED elements group units 47 comprising the LEDs 471.

The present U.S. patent application claims the priority of Japanese Patent Application No. 2006-195661 filed on Jul. 18, 2006, according to the Paris Convention, and the above Japanese Patent Application is the basis for correcting mistranslation of the present U.S. patent application.

What is claimed is:

1. An image forming apparatus comprising:
a photosensitive body;
a print head for exposing the photosensitive body;
a synchronous pattern detection unit which is disposed so as to be integrated into the print head, the synchronous pattern detection unit detecting a synchronous pattern which is previously formed on an unexposed part of the photosensitive body;
a synchronous signal generation unit for generating a synchronous signal based on a detected signal from the synchronous pattern detection unit; and
a control unit for controlling a drive of the print head based on the generated synchronous signal.

2. The image forming apparatus of claim 1, wherein
the photosensitive body comprises the unexposed part at one end or both ends in a main scanning direction of the photosensitive body; and
the synchronous pattern detection unit is disposed at a position corresponding to the unexposed part.

3. The image forming apparatus of claim 1, wherein
the print head comprises a plurality of recording elements arranged in an array in a main scanning direction of the photosensitive body; and
the synchronous pattern detection unit is disposed at one end or both ends of the array.

4. The image forming apparatus of claim 3, wherein the synchronous pattern detection unit is disposed on a same semiconductor substrate as the plurality of recording elements.

5. The image forming apparatus of claim 1, wherein
the synchronous pattern is formed in an optically detectable state; and
the synchronous pattern detection unit detects the synchronous pattern optically.

6. The image forming apparatus of claim 1, wherein
the synchronous pattern is formed in a magnetically detectable state; and
the synchronous pattern detection unit detects the synchronous pattern magnetically.

7. The image forming apparatus of claim 1, wherein
the image forming apparatus is a color image forming apparatus for forming a color image by overlapping a plurality of images having respective colors; and
the image forming apparatus comprises the photosensitive bodies for the respective colors and the print heads for the respective colors.

8. A print head for exposing a photosensitive body disposed in an image forming apparatus, the print head comprising:
a synchronous pattern detection unit which is disposed so as to be integrated into the print head, the synchronous pattern detection unit detecting a synchronous pattern which is previously formed on an unexposed part of the photosensitive body;
a synchronous signal generation unit for generating a synchronous signal based on a detected signal from the synchronous pattern detection unit; and
a control unit for controlling a drive of the print head based on the generated synchronous signal.

9. The print head of claim 8, wherein
the photosensitive body comprises the unexposed part at one end or both ends in a main scanning direction of the photosensitive body; and
the synchronous pattern detection unit is disposed at a position corresponding to the unexposed part.

10. The print head of claim 8, wherein
the print head comprises a plurality of recording elements arranged in an array in a main scanning direction of the photosensitive body; and
the synchronous pattern detection unit is disposed at one end or both ends of the array.

11. The print head of claim 10, wherein the synchronous pattern detection unit is disposed on a same semiconductor substrate as the plurality of recording elements.

12. The print head of claim 8, wherein
the synchronous pattern is formed in an optically detectable state; and
the synchronous pattern detection unit detects the synchronous pattern optically.

13. The print head of claim 8, wherein
the synchronous pattern is formed in a magnetically detectable state; and
the synchronous pattern detection unit detects the synchronous pattern magnetically.
